(19) United States
(12) Patent Application Publication
(10) Pub. No.: US 2026/0289075 A1
(43) Pub. Date: Sep. 24, 2026

(54) INFORMATION PROCESSING APPARATUS, INFORMATION PROCESSING METHOD, AND NON-TRANSITORY COMPUTER READABLE STORAGE MEDIUM

(71) Applicant: LY Corporation, Tokyo (JP)

(72) Inventor: Takashi YAMADA, Tokyo (JP)

(21) Appl. No.: 19/558,000

(22) Filed: Mar. 5, 2026

(30) Foreign Application Priority Data
Mar. 18, 2025 (JP) 2025-044046

(51) Int. Cl. G06F 40/166; G06F 16/9535

(52) U.S. Cl. CPC G06F 40/166; G06F 16/9535

(57) ABSTRACT

An information processing apparatus includes an acquisition unit acquiring user information and history information on a user, an estimation unit estimating a user's subject of interest based on the acquired user information and the acquired history information, a collection unit collecting information on a domain corresponding to the estimated subject of interest from among pieces of information that are distributed via a predetermined domain, a determination unit determining whether or not there is a difference between the collected information on the domain corresponding to the subject of interest and information that corresponds to the subject of interest and that is published via a different domain, a generation unit, when it is determined that there is the difference, generating an introduction content in which the difference is highlighted based on the collected information on the domain corresponding to the subject of interest, and a providing unit providing the introduction content.

### CROSS-REFERENCE TO RELATED APPLICATIONS

The present application claims priority to and incorporates by reference the entire contents of Japanese Patent Application No. 2025-044046 filed in Japan on Mar. 18, 2025.

### BACKGROUND OF THE INVENTION

### 1. Field of the Invention

The present invention is related to an information processing apparatus, an information processing method, and a non-transitory computer readable storage medium.

### 2. Description of the Related Art

Conventionally, various kinds of technologies have been proposed in relation to information provision services for providing to-be-distributed information or the like.

For example, a technology for selecting appropriate to-be-distributed information for each user and providing the information is known (Japanese Laid-open Patent Publication No. 2024-166542). However, in the conventional technologies as described above, it is not always possible to provide a difference between pieces of information. Therefore, there is a need to provide a difference between pieces of information.

### SUMMARY OF THE INVENTION

According to the present application, an information processing apparatus includes an acquisition unit that acquires user information and history information on a user, an estimation unit that estimates a subject of interest of the user based on the acquired user information and the acquired history information, a collection unit that collects information on a domain corresponding to the estimated subject of interest from among pieces of information that are distributed via a predetermined domain, a determination unit that determines whether or not there is a difference between the collected information on the domain corresponding to the subject of interest and information that corresponds to the subject of interest and that is published via a different domain, a generation unit that, when it is determined that there is the difference, generates an introduction content in which the difference is highlighted based on the collected information on the domain corresponding to the subject of interest, and a

[symbol]

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is an explanatory diagram illustrating an overview of an information processing system according to one embodiment;

FIG. 2 is a diagram illustrating a configuration example of a terminal apparatus according to one embodiment;

FIG. 3 is a diagram illustrating a configuration example a server apparatus according to one embodiment;

FIG. 4 is a flowchart illustrating the flow of a process according to one embodiment; and

FIG. 5 is a diagram illustrating an example of a hardware configuration.

### DETAILED DESCRIPTION OF THE PREFERRED EMBODIMENTS

Modes (hereinafter, described as “embodiments”) for carrying out an information processing apparatus, an information processing method, and an information processing program according to the present application will be described in detail below with reference to the drawings. Meanwhile, the information processing apparatus, the information processing method, and the information processing program according to the present application are not limited by the embodiments below. In addition, in the embodiments described below, the same components are denoted by the same reference symbols, and repeated explanation will be omitted.

### 1. Overview of Information Processing System

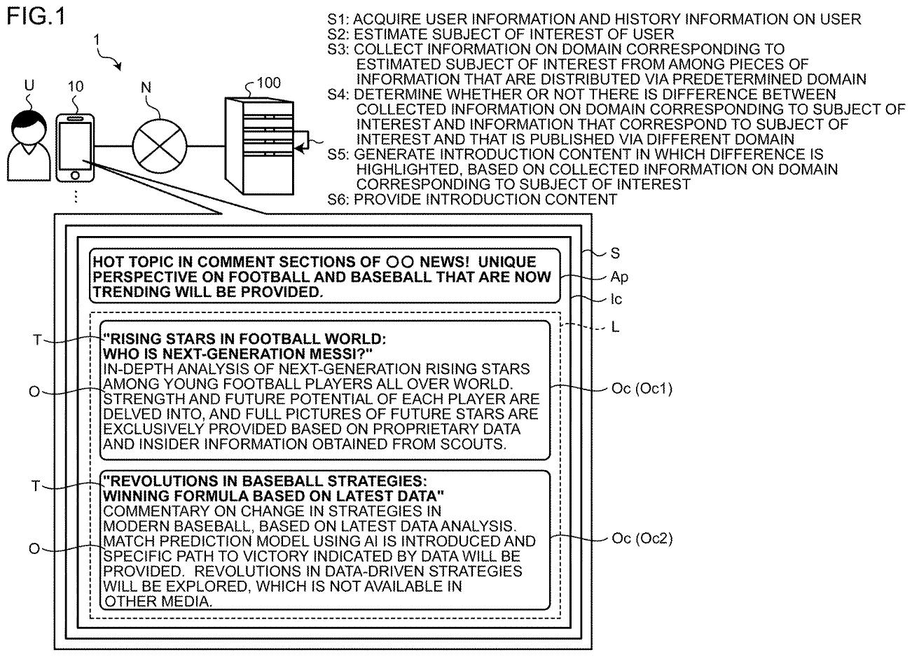

An overview of an information processing system according to one embodiment will be described below with reference to FIG. 1. FIG. 1 is an explanatory diagram illustrating an overview of the information processing system according to one embodiment. As illustrated in FIG. 1, an information processing system 1 according to one embodiment includes a terminal apparatus 10 and a server apparatus 100. The terminal apparatus 10 and the server apparatus 100 are communicably connected to each other in a wired or wireless manner via a network N. Accordingly, the terminal apparatus 10 is able to cooperate with the server apparatus 100. Examples of the network N include a Local Area Network (LAN), a Wide Area Network (WAN), and the Internet.

The terminal apparatus 10 is an information processing apparatus that is used by a user U (user). Examples of the terminal apparatus 10 include a smart device, such as a smartphone (phone) and a tablet terminal, a Personal Computer (PC), such as a desktop PC and a notebook (laptop) PC, a mobile phone, such as a feature phone (Galapagos phone and Galapagos smartphone), a Personal Digital Assistant (PDA), a game console and an audio-visual (AV) device equipped with a communication function, an information home appliance, a digital home appliance, a car navigation system, and a Wearable Device, such as a smart watch, a head mounted display, and smart glasses. Further, the terminal apparatus 10 may be a house, a building, a vehicle, a home appliance, an electronic device, or the like that is compatible with Internet of Things (IOT).

In the present embodiment, the terminal apparatus 10 is a smart device, such as a smartphone or a table terminal, that is used by the user U, and is a mobile terminal apparatus that is able to perform communication with an arbitrary server apparatus via a wireless communication network, such as Long Term Evolution (LTE), 4th Generation (4G), or 5th Generation (5G: 5th generation mobile communication system), Bluetooth (registered trademark), a wireless LAN, or the like. Furthermore, the terminal apparatus 10 includes a screen, such as a liquid crystal display, that has a touch panel function, and receives various kinds of operation, such as tap operation, slide operation, or scroll operation, on display data, such as a content, from the user U by using a finger, a stylus, or the like. Meanwhile, in the screen, operation that is performed in a region in which a content is displayed may be referred to as operation on the content. Moreover, the terminal apparatus 10 is not limited to the smart device, but may be an information processing apparatus, such as a desktop PC or a notebook PC.

The server apparatus 100 is, for example, a computer, such as a PC or a blade server, a mainframe, a workstation, or the like. Meanwhile, the server apparatus 100 may be implemented by cloud computing.

In the present embodiment, the server apparatus 100 is an information processing apparatus that cooperates with the terminal apparatus 10 of each of the users U and provides Application Programming Interface (API) services for various kinds of applications (hereinafter, may be referred to as an app) and various kinds of data to the terminal apparatus 10 of each of the users U, and is implemented by a computer, a cloud system, or the like.

Furthermore, the server apparatus 100 may be an information processing apparatus that provides a certain online service to the terminal apparatus 10 of each of the users U. For example, the server apparatus 100 may provide, as the online service, Internet connection, a search service, a chat service, a dialogue service using voice, images, or moving images, a Social Networking Service (SNS), Electronic Commerce (EC), electronic payment, an online game, online banking, online trading, accommodation/ticket reservation, video/music distribution, news, a map, a route search, route guide, route information, operation information, weather forecast, or the like. In reality, the server apparatus 100 may cooperate with various kinds of servers that provide online services as described above and broker the online services or handle processes of the online services.

Meanwhile, the server apparatus 100 is able to acquire user information on the user U. For example, the server apparatus 100 acquires, as the user information, information (attribute information) on an attribute of the user U, such as gender, age, or an area of residence of the user U. Further, the server apparatus 100 is able to acquire information on an attribute, such as a demographic attribute, a psychographic attribute, a geographic attribute, or a behavioral attribute, of the user U. Furthermore, the server apparatus 100 may acquire, as the user information, a segment, a persona (profile), or the like to which the user U belongs in the field of marketing. Moreover, the server apparatus 100 may store and manage identification information (user ID or the like) that indicates the user U and the information (attribute information) on the attribute of the user U.

Furthermore, the server apparatus 100 acquires various kinds of history information (log data) indicating a behavior of the user U from the terminal apparatus 10 of the user U or various kinds of servers or the like based on the user ID or the like. For example, the server apparatus 100 acquires a location history that is a history of locations or a date and time history of the user U from the terminal apparatus 10. Moreover, the server apparatus 100 acquires a search history that is a history of search queries input by the user U from a search server (search engine). Furthermore, the server apparatus 100 acquires a browsing history that is a history of contents viewed by the user U from a content server. Moreover, the server apparatus 100 acquires a purchase history (payment history) that is a history of product purchases or payment processing of the user U from an electronic commerce server or a payment processing server. Furthermore, the server apparatus 100 may acquire a listing history or a sales history that is a history of listing in the market place by the user U from an electronic commerce server or a payment processing server. Moreover, the server apparatus 100 acquires a posting history that is a history of posting made by the user U from a posting server that provides a service for posting reviews or an SNS server. Meanwhile, the various kinds of servers or the like as described above may be the server apparatus 100 itself. In other words, the server apparatus 100 may function as the various kinds of servers or the like as described above.

Furthermore, the number of each of the apparatuses included in the information processing system 1 illustrated in FIG. 1 is not limited to the number illustrated in the drawings. For example, FIG. 1 illustrates only the single terminal apparatus 10 for the sake of simplicity of the illustration, but the illustration is provided by way of example only and does not constitute a limitation; therefore, it may be possible to provide the two or more terminal apparatuses 10.

Meanwhile, it is assumed that, with respect to processes to be described below, the server apparatus 100 is approved in advance by a creator who creates information, business operators of other domains that provide information, or the like.

The information is, for example, a to-be-distributed content, and is preferably, for example, a news content.

In the present embodiment, for example, the server apparatus 100 is operated and managed by a service business operator that operates a news site (hereinafter, appropriately described as a predetermined domain). The server apparatus 100 provides the news content via the news site. The server apparatus 100 may distribute a news content that is created by a service business operator (hereinafter, appropriately described as a subject company) of the server apparatus 100 via the predetermined domain, or distribute a news content that is submitted from outside to the subject company via the predetermined domain.

### 2. Generation of Introduction Content

### 2-1. Basic Process

In the present embodiment, the server apparatus 100 generates a content in which a difference between pieces of information is highlighted. For example, the server apparatus 100 estimates a subject of interest of the user U, generates an introduction content that highlights a difference between information, which corresponds to the subject of interest and which is distributed via a predetermined domain corresponding to the subject of interest, and information, which corresponds to the subject of interest and which is distributed via a different domain, and provides the introduction content to the user U. For example, the information is a to-be-distributed content that is distributed to the user U.

Meanwhile, the server apparatus 100 implements a mechanism as described above by Artificial Intelligence (AI), such as Generative Pre-trained Transformer (GPT).

GPT is text generation AI, and is a language model that is able to generate sentences using natural language processing. However, GPT is only one example of AI. In reality, it is possible to use similar technologies.

For example, the server apparatus 100 acquires the user information and the history information on the user U (Step S1).

Subsequently, the server apparatus 100 estimates a subject of interest of the user U (Step S2). For example, the server apparatus 100 estimates the subject of interest of the user U based on the acquired user information and the acquired history information on the user U. Further, the server apparatus 100 estimates the subject of interest of the user U based on an account or a genre that the user U follows. Furthermore, for example, when a news tab of an application for providing news is customized, the server apparatus 100 estimates the subject of interest of the user U based on the customized tab. Moreover, for example, the server apparatus 100 estimates the subject of interest of the user U based on information that is posted on an SNS by the user U. Furthermore, for example, the server apparatus 100 may cause AI to estimate the subject of interest of the user U. For example, the server apparatus 100 may cause AI to calculate a score (or an index) that indicates a degree of interest for each of article events (themes or the like) that are viewed by the user U, compare scores of a plurality of subjects, and determine subjects within a predetermined rank (for example, within the top 10) as the subject of interest of the user U. Alternatively, the server apparatus 100 may cause AI to compare the score of each of the article events with a threshold, determine whether the score of each of the article events is equal to or larger than the threshold, and determine an event for which the score is equal to or larger than the threshold as the subject of interest of the user U.

The subject of interest of the user U is a subject in which the user U is interested. For example, the subject of interest of the user U may be a person or a group, such as an idol or an actor, a team, such as a baseball team or a football team, a work, such as manga, anime, a novel, a drama, or a movie, an object of a hobby or preference, such as a car or a train, a specific genre, such as music or fashion, a specific event that is held on a fixed date every year, a certain item, or a certain event.

Subsequently, the server apparatus 100 collects information on a domain corresponding to the estimated subject of interest of the user U from among pieces of information that are distributed via the predetermined domain (Step S3).

For example, the server apparatus 100 collects a news content that corresponds to the subject of interest of the user U from among news contents that are distributed via the predetermined domain. The server apparatus 100 collects at least one of a news content that corresponds to the subject of interest of the user U and that is created by the subject company and a news content that corresponds to the subject of interest of the user U and that is submitted from outside to the subject company. The server apparatus 100 collects a news content that corresponds to a Category corresponding to the subject of interest of the user U.

Meanwhile, the process of estimating the subject of interest of the user U at Step S2 as described above and the process of collecting the information on the domain corresponding to the subject of interest of the user U at Step S3 as described above may be performed at the same time with or parallel to Step S1 as described above or may be performed in the process at Step S1 as described above.

Subsequently, the server apparatus 100 determines whether or not there is a difference between the collected information on the domain corresponding to the subject of interest and information that corresponds to the subject of interest and that is published via a different domain (Step S4).

For example, the server apparatus 100 searches for, by a search engine, an expression that is included in the collected information (collected news content) on the domain corresponding to the subject of interest, and determines whether or not a search result is obtained (whether or not the number of obtained search results is zero). The server apparatus 100 searches for, by the search engine, at least one of an expression in a title and an expression in a content of the collected news content of the domain corresponding to the subject of interest, and determines whether or not a search result is obtained. When a search result is not obtained through the search by the search engine (when the number of obtained search results is zero), the server apparatus 100 determines that there is a difference between the collected information on the domain corresponding to the subject of interest and the information that corresponds to the subject of interest and that is published via the different domain. When a search result is obtained (when the number of obtained search results is equal to or larger than one), the server apparatus 100 determines whether or not there is a difference between the collected information on the domain corresponding to the subject of interest and the information that corresponds to the subject of interest and that is published via the different domain based on the number of obtained search results of the search result. For example, when the search result is obtained, the server apparatus 100 determines whether or not the number of obtained search results is smaller than a threshold, and determines that there is a difference between the collected information on the domain corresponding to the subject of interest and the information that corresponds to the subject of interest and that is published via the different domain when the number of obtained search results is smaller than the threshold. The expression included in an article may be, for example, a keyword of the article. The different domain is a domain that is different from the predetermined domain that manages the server apparatus 100. The different domain may be, for example, a domain of a news site different from the predetermined domain, or a domain of an SNS or the like.

The server apparatus 100 may determine whether or not there is a difference by comparing details of the collected information on the domain corresponding to the subject of interest and details of the information that corresponds to the subject of interest and that is published via the different domain. For example, when the number of obtained search results is equal to or larger than the threshold, the server apparatus 100 may calculate a degree of difference (degree of deviation) between the collected information on the domain corresponding to the subject of interest and the information that corresponds to the subject of interest and that is published via the different domain. When a threshold for the degree of deviation is equal to or larger than a threshold, the server apparatus 100 may determine that there is a difference between the collected information on the domain corresponding to the subject of interest and the information that corresponds to the subject of interest and that is published via the different domain. Alternatively, the server apparatus 100 calculates a similarity between the collected information on the domain corresponding to the subject of interest and the information that corresponds to the subject of interest and that is published via the different domain, and determines that there is no difference (there is a similarity) when the similarity is equal to or larger than the threshold. For example, the server apparatus 100 may vectorize each of the collected information on the domain corresponding to the subject of interest and the information that corresponds to the subject of interest and that is published via the different domain, and calculate the degree of difference or the similarity based on Cosine Similarity of multidimensional vectors. Furthermore, the server apparatus 100 may calculate the degree of difference or the similarity even when the number of obtained search results is smaller than the threshold. However, the above-described cases are mere examples. In reality, embodiments are not limited to the examples as described above.

The server apparatus 100 generates an introduction content Ic in which the difference is highlighted, based on the collected information on the domain (Step S5). When determining that there is a difference, the server apparatus 100 generates the introduction content Ic in which the difference is highlighted, based on the collected information on the domain corresponding to the subject of interest. The server apparatus 100 generates the introduction content Ic for each of the users U. The server apparatus 100 generates the introduction content Ic while changing details for each of the users U. The server apparatus 100 generates, for each of the users U, the introduction content Ic such that the user U wants to view information (news content) that is provided by the introduction content Ic.

The introduction content Ic includes a list L and an appeal text Ap. The list L is a list of extracted information, which is different from the information that corresponds to the subject of interest and that is published via the different domain, among pieces of information that are distributed via the predetermined domain. The list L is a content list of extracted contents (original contents) that include different information from information that is published via the different domain. The list L is a content list obtained by extracting, from the collected information on the domain corresponding to the subject of interest, an original content including different information from the information that corresponds to the subject of interest and that is published via the different domain. The list L includes an overview content Oc that indicates an overview of the extracted original content. The overview content Oc includes a title T and an overview text O. The title T and the overview text O of the overview content Oc is generated based on the content that is to be provided to the user U. The appeal text Ap is an overview text for explaining the list L. The appeal text Ap is a sentence for appealing the overview content Oc. In other words, the appeal text Ap is an overview text for appealing the list L. The overview content Oc and the appeal text Ap are generated such that the user U wants to view the original content. The original content may include a news content that is submitted from outside. The title T of the overview content Oc may be a title that is described in the content to be provided to the user U.

For example, when determining that there is a difference, the server apparatus 100 extracts, from among pieces of information that are distributed via the predetermined domain, different information from information that is published via the different domain.

The server apparatus 100 extracts a content (original content) that includes different information from the information that is published via the different domain.

The server apparatus 100 extracts the original content from the collected information on the domain corresponding to the subject of interest. The server apparatus 100 extracts the original content for each of the users U. The server apparatus 100 makes a list of the extracted original content. The server apparatus 100 generates the overview content Oc that indicates an overview of the listed original content. The server apparatus 100 generates the title T and the overview text O of the overview content Oc. The server apparatus 100 generates the title T and the overview text O based on the content that is to be provided to the user U. The server apparatus 100 generates, for each of the users U, the title T and the overview text O such that the user U wants to view the original content, based on the content that is to be provided to the user U. Specifically, the server apparatus 100 generates the overview content Oc by changing, for each of the users U, details of the title T and details of the overview text O such that the user U wants to view the original content.

In the example illustrated in FIG. 1, the introduction content Ic that is displayed on a screen S of the terminal apparatus 10 includes two overview contents Oc1 and Oc2, but the number of the overview contents is not limited to two.

The server apparatus 100 generates the appeal text Ap. The server apparatus 100 generates the appeal text Ap based on the list L that is to be provided to the user U. The server apparatus 100 generates, for each of the users U, the appeal text Ap based on the list L that is to be provided to the user U. More specifically, the server apparatus 100 generates, for each of the users U, the appeal text Ap such that the user U wants to view the original content, based on the overview content Oc that is to be provided to the user U. In other words, the server apparatus 100 generates, for each of the users U, the appeal text Ap by changing, for each of the users U, details of the appeal text Ap such that the user U wants to view the original content.

Specifically, the server apparatus 100 generates the introduction content Ic by using generative AI. The server apparatus 100 inputs, to the generative AI, the user information and the history information on the user U and instruction information for generating the introduction content Ic, and causes the generative AI to generate the introduction content Ic. The server apparatus 100 inputs, to the generative AI, for example, instruction information for generating, for each of the users U, the introduction content Ic that includes the appeal text Ap for causing the user U to perform operation (tap, click, or the like) on the introduction content Ic and the content information C, and causes the generative AI to generate the introduction content Ic.

Subsequently, the server apparatus 100 provides the introduction content Ic (Step S6). For example, the server apparatus 100 provides the introduction content Ic through a push notification. The server apparatus 100 may display, for example, the three or more overview contents Oc.

Further, the server apparatus 100 may display only the appeal text Ap, and display the overview content Oc when the user U performs operation on the introduction content Ic. Furthermore, the server apparatus 100 may display the content information C and information indicating display of more information (“display more”, “view more”, or the like), and display the remaining overview content Oc when the user U performs operation on the information indicating display of more information.

### 2-2. Optimization of Introduction Content

The server apparatus 100 may collect a reaction of the user U, and optimize the introduction content Ic based on the collected reaction. The reaction of the user U may operation on the introduction content Ic, feedback, or the like. The server apparatus 100 collects, for example, the number of taps (the number of clicks) performed by the user U on the introduction content Ic, and optimizes the introduction content Ic based on the collected number of taps. An optimization unit 136 collects, for example, browsing information on a content that is introduced by the introduction content Ic and that is browsed by the user U, and optimizes the introduction content Ic based on the collected browsing information. The browsing information includes, for example, a browsing time of the content that is provided (introduced) to the user U, line-of-sight information, viewpoint information, or the like. Furthermore, the server apparatus 100 causes the user U to input feedback, and optimizes the introduction content Ic based on the feedback.

Moreover, the server apparatus 100 may optimize a notification timing that is a timing at which a notification of the introduction content Ic is given.

For example, the server apparatus 100 estimates a behavior pattern of the user U. The server apparatus 100 collects a reaction of the user U, and estimates a period of time in which the user U does not give a response or a period of time in which the user U gives a response, based on the acquired user information and the acquired history information on the user U. When, for example, a time or a behavior of the user U is input to a trained model that has been trained based on the user information and the history information, the server apparatus 100 may estimate a behavior of the user U. The behavior pattern may be, for example, an offline behavior pattern, such as commuting, commuting to school, sleeping hours, lunch time, or shopping in a physical store, or an online behavior pattern, such as a search behavior or online shopping. The server apparatus 100 sends a push notification with respect to the introduction content Ic based on the estimated behavior pattern of the user U.

In this manner, in the present embodiment, the server apparatus 100 acquires the user information and the history information on the user U, estimates a subject of interest of the user U, collects information on a domain corresponding to the estimated subject of interest, and generates an introduction content in which a difference from information that corresponds to the subject of interest and that is published via a different domain is highlighted based on the collected information. Therefore, the server apparatus 100 is able to provide a difference in information. Accordingly, the server apparatus 100 is able to encourage the user U to access a predetermined domain that has provided the difference in information. Further, the server apparatus 100 changes details of the introduction content Ic for each of the users U, and gives a notification to the user U. Furthermore, the server apparatus 100 collects a rection of the user U and optimizes the introduction content. Therefore, the server apparatus 100 is able to provide a difference in information.

### 3. Configuration Example of Terminal Apparatus

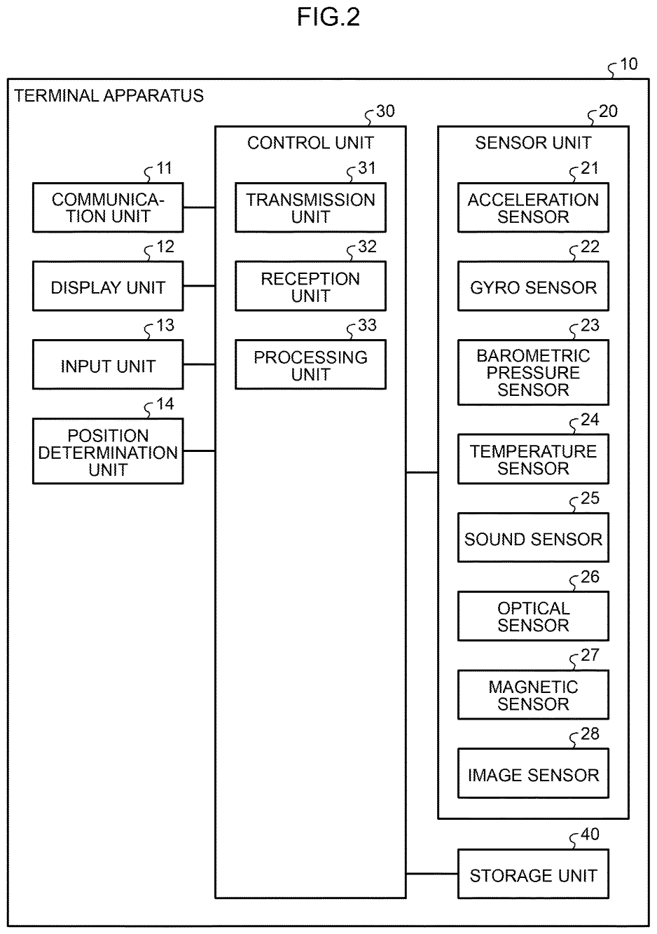

A configuration of the terminal apparatus 10 will be described below with reference to FIG. 2. FIG. 2 is a diagram illustrating a configuration example of the terminal apparatus 10 according to one embodiment. As illustrated in FIG. 2, the terminal apparatus 10 includes a communication unit 11, a display unit 12, an input unit 13, a position determination unit 14, a sensor unit 20, a control unit 30 (controller), and a storage unit 40.

### Communication Unit 11

The communication unit 11 is connected to the network N in a wired or wireless manner, and transmits and receives information to and from the server apparatus 100 via the network N. For example, the communication unit 11 is implemented by a Network Interface Card (NIC), an antenna, or the like.

### Display Unit 12

The display unit 12 is a display device that displays various kinds of information, such as location information. For example, the display unit 12 is a Liquid Crystal Display (LCD) or an Organic Electro-Luminescent (EL) Display. Further, the display unit 12 is a display of a touch panel type, but embodiments are not limited to this example.

### Input Unit 13

The input unit 13 is an input device that receives various kinds of operation from the user U. For example, the input unit 13 includes a button for inputting characters, numeral, or the like. Meanwhile, the input unit 13 may be an input-output port (I/O port), a Universal Serial Bus (USB) port, or the like. Further, when the display unit 12 is a display of a touch panel type, a part of the display unit 12 functions as the input unit 13.

Furthermore, the input unit 13 may be a microphone or the like that receives voice input from the user U. The microphone may be of a wireless type.

### Position Determination Unit 14

The position determination unit 14 receives a signal (radio wave) that is sent from a Global Positioning System (GPS) satellite, and acquires location information (for example, latitude and longitude) that indicates a current location of the terminal apparatus 10 that is a subject apparatus based on the received signal. In other words, the position determination unit 14 determines the location of the terminal apparatus 10. Meanwhile, a GPS is one example of a Global Navigation Satellite System (GNSS).

Furthermore, the position determination unit 14 is able to determine the location by various kinds of methods, other than the GPS. For example, the position determination unit 14 may determine the location by various kinds of communication functions of the terminal apparatus 10 as described below, as an auxiliary positioning means for location adjustment or the like.

### Wi-Fi Positioning

For example, the position determination unit 14 determines the location of the terminal apparatus 10 by using a Wi-Fi (registered trademark) communication function of the terminal apparatus 10 or a communication network provided by each of communication companies. Specifically, the position determination unit 14 determines the location of the terminal apparatus 10 by performing Wi-Fi communication or the like and determining a distance to a neighboring base station or a neighboring access point.

### Beacon Positioning

Furthermore, the position determination unit 14 may determine the location by using a Bluetooth (registered trademark) function of the terminal apparatus 10. For example, the position determination unit 14 determines the location of the terminal apparatus 10 by connecting to a beacon transmitter that is connected by the Bluetooth (registered trademark) function.

### Geomagnetic Positioning

Moreover, the position determination unit 14 determines the location of the terminal apparatus 10 based on a geomagnetic pattern of a structure that is measured in advance and a geomagnetic sensor that is included in the terminal apparatus 10.

### RFID Positioning

Furthermore, for example, when the terminal apparatus 10 includes a function for a Radio Frequency Identification (RFID) tag that is equivalent to a contactless IC card that is used at a station ticket gate, a store, or the like or a function for reading the RFID tag, information indicating payment or the like by the terminal apparatus 10 and a location of use are recorded. The position determination unit 14 may determine the location of the terminal apparatus 10 by acquiring the above-described information. Further, it may be possible to determine the location by using an optical sensor, an infrared sensor, or the like that is included in the terminal apparatus 10.

The position determination unit 14 may determine the location of the terminal apparatus 10 using one or a combination of the positioning means as described above if needed.

### Sensor Unit 20

The sensor unit 20 includes various kinds of sensors that are mounted on or connected to the terminal apparatus 10. Meanwhile, the connection may be any of a wired connection and a wireless connection. For example, each of the sensors may be a detection apparatus, such as a wearable device or a wireless device, other than the terminal apparatus 10. In the example illustrated in FIG. 2, the sensor unit 20 includes an acceleration sensor 21, a gyro sensor 22, a barometric pressure sensor 23, a temperature sensor 24, a sound sensor 25, an optical sensor 26, a magnetic sensor 27, and an image sensor (camera) 28.

Meanwhile, the sensors 21 to 28 as described above are illustrated by way of example only, and embodiments are not limited to this example. In other words, the sensor unit 20 may include a part of the sensors 21 to 28, or further include a different sensor, such as a humidity sensor, in addition to or in place of each of the sensors 21 to 28.

The acceleration sensor 21 is, for example, a triaxial accelerometer, and detects physical movement of the terminal apparatus 10, such as a moving direction, a velocity, and an acceleration of the terminal apparatus 10. The gyro sensor 22 detects physical movement of the terminal apparatus 10, such as inclination in a three-axis direction, based on an angular velocity or the like of the terminal apparatus 10. For example, the barometric pressure sensor 23 detects air pressure around the terminal apparatus 10.

The terminal apparatus 10 includes the acceleration sensor 21, the gyro sensor 22, the barometric pressure sensor 23, and the like as described above, and therefore, it is possible to determine the location of the terminal apparatus 10 by using a technology, such as Pedestrian Dead-Reckoning (PDR), using each of the sensors 21 to 23. With this configuration, it is possible to acquire indoor location information that is difficult to acquire by a positioning system, such as a GPS.

For example, it is possible to calculate the number of steps, a walking speed, or a walking distance by a pedometer using the acceleration sensor 21. Further, it is possible to obtain a traveling direction, a line-of-sight direction, or inclination of the body of the user U by using the gyro sensor 22. Furthermore, it is possible to obtain an altitude or a floor number at which the terminal apparatus 10 of the user U is present, based on the air pressure that is detected by the barometric pressure sensor 23.

The temperature sensor 24 detects, for example, temperature around the terminal apparatus 10. The sound sensor 25 detects, for example, sound around the terminal apparatus 10. The optical sensor 26 detects illuminance around the terminal apparatus 10. The magnetic sensor 27 detects, for example, geomagnetism around the terminal apparatus 10. The image sensor 28 captures an image around the terminal apparatus 10.

Each of the barometric pressure sensor 23, the temperature sensor 24, the sound sensor 25, the optical sensor 26, and the image sensor 28 as described above is able to detect an environment, a situation, or the like around the terminal apparatus 10 by detecting air pressure, temperature, sound, or illuminance or by capturing a surrounding image. Further, it is possible to improve accuracy of the location information on the terminal apparatus 10 based on the environment, the situation, or the like around the terminal apparatus 10.

### Control Unit 30

The control unit 30 includes, for example, a microcomputer or various kinds of circuitries including a Central Processing Unit (CPU) or a Micro Processing Unit (MPU), a Read Only Memory (ROM), a Random Access Memory (RAM), an input-output port, and the like. Further, the control unit 30 may include hardware, for example, an integrated circuit, such as an Application Specific Integrated Circuit (ASIC) or a Field Programmable Gate Array (FPGA). The control unit 30 includes a transmission unit 31, a reception unit 32, and a processing unit 33.

### Transmission Unit 31

The transmission unit 31 is able to transmit, for example, various kinds of information that are input by the user U by using the input unit 13, various kinds of information that are detected by the sensors 21 to 28 that are mounted on or connected to the terminal apparatus 10, the location information on the terminal apparatus 10 that is determined by the position determination unit 14, or the like to the server apparatus 100 via the communication unit 11.

### Reception Unit 32

The reception unit 32 is able to receive, via the communication unit 11, various kinds of information that are determined by the server apparatus 100 and a request for various kinds of information from the server apparatus 100.

### Processing Unit 33

The processing unit 33 controls the entire terminal apparatus 10 including the display unit 12 and the like.

For example, the processing unit 33 is able to output, to the display unit 12, various kinds of information that are transmitted by the transmission unit 31 or various kinds of information that the reception unit 32 has received from the server apparatus 100, and cause the display unit 12 to display the various kinds of information.

### Storage unit 40

The storage unit 40 is implemented by, for example, a semiconductor memory device, such as a Random Access Memory (RAM) or a flash memory, or a storage device, such as a Hard Disk Drive (HDD), a Solid State Drive (SSD), or an optical disk. The storage unit 40 stores therein various kinds of program, various kinds of data, or the like.

### 4. Configuration Example of Server Apparatus

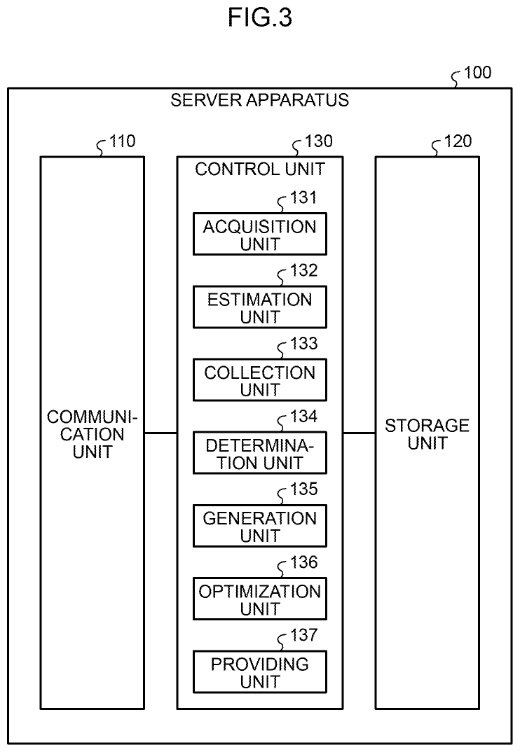

A configuration of the server apparatus 100 according to one embodiment will be described below with reference to FIG. 3. FIG. 3 is a diagram illustrating a configuration example of the server apparatus 100 according to one embodiment. As illustrated in FIG. 3, the server apparatus 100 includes a communication unit 110, a storage unit 120, and a control unit 130.

### Communication Unit 110

The communication unit 110 is implemented by, for example, a Network Interface Card (NIC) or the like.

Further, the communication unit 110 is connected to the network N in a wired or wireless manner.

### Storage unit 120

The storage unit 120 is implemented by, for example, a semiconductor memory device, such as a Random Access Memory (RAM) or a flash memory, or a storage device, such as an HDD, an SSD, or an optical o disk. The storage unit 120 may store therein the identification information (user ID or the like) that indicates the user U and the attribute information and the history information (log data) on the user U.

### Control Unit 130

The control unit 130 is a controller, and implemented by, for example, causing a Central Processing Unit (CPU), a Micro Processing Unit (MPU), a Graphics Processing Unit (GPU), an Application Specific Integrated Circuit (ASIC), a Field Programmable Gate Array (FPGA), or the like to execute various kinds of programs (corresponding to one example of the information processing program) that are stored in a storage device inside the server apparatus 100, by using a storage area, such as a RAM, as a work area. In the example illustrated in FIG. 3, the control unit 130 includes an acquisition unit 131, an estimation unit 132, a collection unit 133, a determination unit 134, a generation unit 135, the optimization unit 136, and a providing unit 137.

### Acquisition Unit 131

The acquisition unit 131 acquires a search query that is input by the user U (user). For example, when the user U inputs a search query in a search engine or the like and performs a keyword search, the acquisition unit 131 acquires the search query via the communication unit 110. Specifically, the acquisition unit 131 acquires a keyword, which is input to a search window of the search engine, a site, or an application by the user U, via the communication unit 110.

Furthermore, the acquisition unit 131 acquires user information on the user U via the communication unit 110. For example, the acquisition unit 131 acquires, from the terminal apparatus 10 of the user U, the identification information (user ID or the like) indicating the user U, the location information on the user U, the attribute information on the user U, or the like. Moreover, the acquisition unit 131 may acquire the identification information indicating the user U, the attribute information on the user U, or the like when the user U performs user registration. Then, the acquisition unit 131 stores the user information in the storage unit 120.

Furthermore, the acquisition unit 131 acquires various kinds of history information (log data) that indicates a behavior of the user U via the communication unit 110. For example, the acquisition unit 131 acquires, from the terminal apparatus 10 of the user U or various kinds of servers or the like based on the user ID or the like, various kinds of history information indicating a behavior of the user U. Then, the acquisition unit 131 stores the various kinds of history information in the storage unit 120.

### Estimation Unit 132

The estimation unit 132 estimates a subject of interest of the user U. For example, the estimation unit 132 estimates the subject of interest of the user U based on the acquired user information and the acquired history information on the user U. Further, the estimation unit 132 estimates the subject of interest of the user U based on an account or a genre that the user U follows. Furthermore, for example, when a news tab of an application for providing news is customized, the estimation unit 132 estimates the subject of interest of the user U based on the customized tab. Moreover, for example, the estimation unit 132 estimates the subject of interest of the user U based on information that is posted on an SNS by the user U. Furthermore, for example, the estimation unit 132 may cause AI to estimate the subject of interest of the user U. For example, the estimation unit 132 may cause AI to calculate a score (or an index) that indicates a degree of interest for each of article events (themes or the like) that are viewed by the user U, compare scores of a plurality of subjects, and determine subjects within a predetermined rank (for example, within the top 10) as the subject of interest of the user U. Alternatively, the estimation unit 132 may cause AI to compare the score of each of the article events with a threshold, determine whether the score of each of the article events is equal to or larger than the threshold, and determine an event for which the score is equal to or larger than the threshold as the subject of interest of the user U.

### Collection Unit 133

The collection unit 133 collects information on a domain corresponding to the estimated subject of interest of the user U from among pieces of information that are distributed via the predetermined domain. For example, the collection unit 133 collects information on a domain that corresponds to the estimated subject of interest of the user U from among pieces of information that are distributed via a domain of the subject company. The collection unit 133 collects at least one of information on a news content that corresponds to the subject of interest of the user U and that is created by the subject company and information on a news content that corresponds to the subject of interest of the user U and that is submitted from outside to the subject company. The collection unit 133 collects a news content that corresponds to a category corresponding to the subject of interest of the user U.

### Determination Unit 134

The determination unit 134 determines whether or not there is a difference between the collected information on the domain corresponding to the subject of interest and information that corresponds to the subject of interest and that is published via a different domain.

For example, the determination unit 134 searches for, by a search engine, an expression that is included in the collected information (collected news content) on the domain corresponding to the subject of interest, and determines whether or not a search result is obtained (whether or not the number of obtained search results is zero). The determination unit 134 searches for, by the search engine, at least one of an expression in a title and an expression in a content of the collected news content of the domain corresponding to the subject of interest, and determines whether or not a search result is obtained. When a search result is not obtained through the search by the search engine (when the number of obtained search results is zero), the determination unit 134 determines that there is a difference between the collected information on the domain corresponding to the subject of interest and the information that corresponds to the subject of interest and that is published via the different domain. When a search result is obtained (when the number of obtained search results is equal to or larger than one), the determination unit 134 determines whether or not there is a difference between the collected information on the domain corresponding to the subject of interest and the information that corresponds to the subject of interest and that is published via the different domain based on the number of obtained search results of the search result. For example, when the search result is obtained, the determination unit 134 determines whether or not the number of obtained search results is smaller than a threshold, and determines that there is a difference between the collected information on the domain corresponding to the subject of interest and the information that corresponds to the subject of interest and that is published via the different domain when the number of obtained search results is smaller than the threshold.

The determination unit 134 may determine whether or not there is a difference by comparing details of the collected information on the domain corresponding to the subject of interest and details of the information that corresponds to the subject of interest and that is published via the different domain. For example, when the number of obtained search results is equal to or larger than the threshold, the determination unit 134 may calculate a degree of difference (degree of deviation) between the collected information on the domain corresponding to the subject of interest and the information that corresponds to the subject of interest and that is published via the different domain. When a value for the degree of deviation is equal to or larger than a threshold, the determination unit 134 may determine that there is a difference between the collected information on the domain corresponding to the subject of interest and the information that corresponds to the subject of interest and that is published via the different domain. Alternatively, the determination unit 134 calculates a similarity between the collected information on the domain corresponding to the subject of interest and the information that corresponds to the subject of interest and that is published via the different domain, and determines that there is no difference (there is a similarity) when the similarity is equal to or larger than the threshold. For example, the determination unit 134 may vectorize each of the collected information on the domain corresponding to the subject of interest and the information that corresponds to the subject of interest and that is published via the different domain, and calculate the degree of difference or the similarity based on Cosine Similarity of multidimensional vectors. Furthermore, the determination unit 134 may calculate the degree of difference or the similarity even when the number of obtained search results is smaller than the threshold.

### Generation Unit 135

The generation unit 135 generates the introduction content Ic in which the difference is highlighted. When the determination unit 134 determines that there is a difference, the generation unit 135 generates the introduction content Ic in which the difference is highlighted, based on the collected information on the domain corresponding to the subject of interest. The generation unit 135 generates the introduction content Ic for each of the users U. The generation unit 135 generates the introduction content Ic while changing details for each of the users U.

For example, when determining that there is a difference, the generation unit 135 extracts, from among pieces of information that are distributed via the predetermined domain, information that is different from information that is published via the different domain. The generation unit 135 extracts a content (original content) that includes information different from the information that is published via the different domain. The generation unit 135 extracts the original content from the collected information on the domain corresponding to the subject of interest. The generation unit 135 extracts the original content for each of the users U. The generation unit 135 makes a list of the extracted original content. The generation unit 135 generates the overview content Oc that indicates an overview of the listed original content. The generation unit 135 generates the title T and the overview text O of the overview content Oc. The generation unit 135 generates, for each of the users U, the title T and the overview text O such that the user U wants to view the original content, based on the content that is to be provided to the user U. Specifically, the generation unit 135 generates the overview content Oc by changing, for each of the users U, details of the title T and details of the overview text O such that the user U wants to view the original content.

The generation unit 135 generates the appeal text Ap. The server apparatus 100 generates the appeal text Ap based on the list L that is to be provided to the user U. The server apparatus 100 generates, for each of the users U, the appeal text Ap based on the list L that is to be provided to the user U. More specifically, the generation unit 135 generates, for each of the users U, the appeal text Ap such that the user U wants to view the original content, based on the overview content Oc that is to be provided to the user U. In other words, the generation unit 135 generates, for each of the users U, the appeal text Ap by changing, for each of the users U, details of the appeal text Ap such that the user U wants to view the original content.

Specifically, the generation unit 135 generates the introduction content Ic by using generative AI. The generation unit 135 inputs, to the generative AI, the user information and the history information on the user U and instruction information for generating the introduction content Ic, and causes the generative AI to generate the introduction content Ic. The generation unit 135 inputs, to the generative AI, for example, instruction information for generating, for each of the users U, the introduction content Ic that includes the appeal text Ap for causing the user U to perform operation (tap, click, or the like) on the introduction content Ic and the content information C, and causes the generative AI to generate the introduction content Ic.

### Optimization Unit 136

The optimization unit 136 collects a reaction of the user U, and optimizes the introduction content Ic based on the collected reaction. The optimization unit 136 collects, for example, the number of taps (the number of clicks) performed by the user U on the introduction content Ic, and optimizes the introduction content Ic based on the collected number of taps. The optimization unit 136 collects, for example, browsing information on a content that is introduced by the introduction content Ic and that is browsed by the user U, and optimizes the introduction content Ic based on the collected browsing information. Furthermore, the optimization unit 136 causes the user U to input feedback, and optimizes the introduction content Ic based on the feedback.

The optimization unit 136 may optimize a notification timing that is a timing at which a notification of the introduction content Ic is given.

For example, the optimization unit 136 estimates a behavior pattern of the user U. The optimization unit 136 collects a reaction of the user U, and estimates a period of time in which the user U does not give a response or a period of time in which the user U gives a response, based on the acquired user information and the acquired history information on the user U. For example, when a time or a behavior of the user U is input to a trained model that has been trained based on the user information and the history information, the optimization unit 136 may estimate a behavior of the user U.

### Providing Unit 137

The providing unit 137 provides the introduction content Ic. For example, the providing unit 137 provides the introduction content Ic through a push notification.

The providing unit 137 provides the introduction content Ic by displaying the introduction content Ic on the terminal apparatus 10 of the user U through a push notification.

The providing unit 137 sends a push notification with respect to the optimized introduction content Ic based on the estimated behavior pattern of the user U, for example.

Meanwhile, the providing unit 137 may be a display control unit that controls, by API or the like, screen display of the terminal apparatus 10 of the user U. In FIG. 1, for example, the providing unit 137 may display the three or more overview contents Oc. Further, the providing unit 137 may display only the appeal text Ap, and display the overview content Oc when the user U performs operation on the introduction content Ic. Furthermore, the providing unit 137 may display the overview content C and information indicating display of more information, and display the remaining overview content Oc when the user U performs operation on the information indicating display of more information.

### 5. Flow of Process

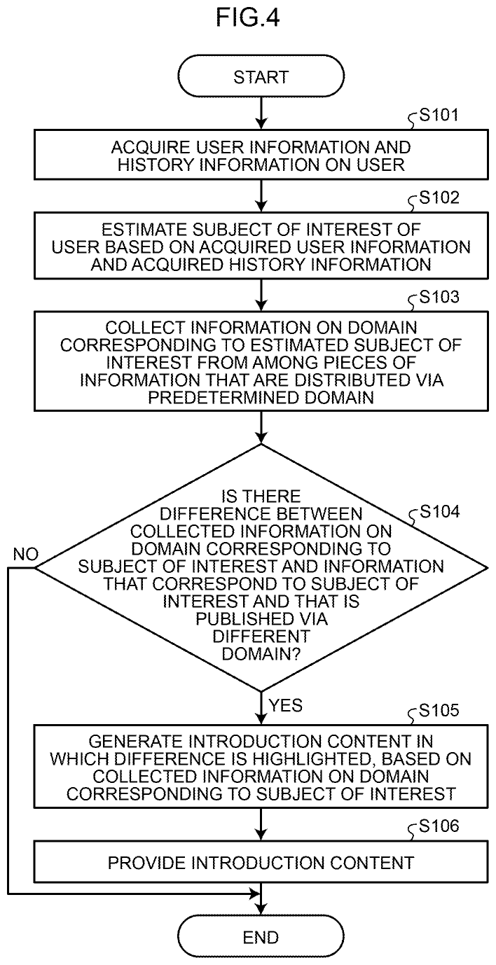

A flow of a process performed by the server apparatus 100 according to one embodiment will be described below with reference to FIG. 4. FIG. 4 is a flowchart illustrating the flow of the process according to one embodiment. Meanwhile, the flow of the process described below is repeated by the control unit 130 of the server apparatus 100.

for example, as illustrated in FIG. 4, the acquisition unit 131 of the server apparatus 100 acquires the user information and the history information on the user U (Step S101).

Subsequently, the estimation unit 132 of the server apparatus 100 estimates the subject of interest of the user U based on the acquired user information and the acquired history information (Step S102).

Then, the collection unit 133 of the server apparatus 100 collects information on a domain corresponding to the estimated subject of interest from among pieces of information that are distributed via a predetermined (Step S103).

Subsequently, the determination unit 134 of the server apparatus 100 determines whether or not there is a difference between the collected information on the domain corresponding to the subject of interest and the information that corresponds to the subject of interest and that is published via the different domain (Step S104).

When the determination unit 134 determines that there is no difference between the collected information on the domain corresponding to the subject of interest and the information that corresponds to the subject of interest and that is published via the different domain (Step S104; No), the process is terminated.

When the determination unit 134 determines that there is a difference between the collected information on the domain corresponding to the subject of interest and the information that corresponds to the subject of interest and that is published via the different domain (Step S104; Yes), the generation unit 135 of the server apparatus 100 generates the introduction content Ic in which the difference is highlighted based on the collected information on the domain corresponding to the subject of interest (Step S105).

Then, the providing unit 137 of the server apparatus 100 provides the introduction content Ic to the user U (Step S106).

Meanwhile, even when it is determined that there is no difference at Step S104, the server apparatus 100 may return to Step S103 and collect information again.

### 6. Modifications

The terminal apparatus 10 and the server apparatus 100 as described above may be embodied in various different modes other than the embodiment as described above. Therefore, modifications of one embodiment will be described below.

In one embodiment as described above, a part or all of the process that is performed by the server apparatus 100 may be performed by, in reality, the terminal apparatus 10 (or an application that runs on the terminal apparatus 10). For example, the process may be completed by Stand-alone (by the terminal apparatus 10 alone). In this case, it is assumed that the terminal apparatus 10 has the functions of the server apparatus 100 of one embodiment as described above. Further, in one embodiment as described above, the terminal apparatus 10 cooperates with the server apparatus 100, and therefore, from the perspective of the user U, it looks like the terminal apparatus 10 performs the processes of the server apparatus 100. In other words, from another perspective, it can be said that the terminal apparatus 10 includes the server apparatus 100.

Furthermore, in one embodiment as described above, it is explained that the server apparatus 100 adopts the news content as the information; however, in reality, embodiments are not limited to the text information on the news content, but it may be possible to compare a detail, such as an image, voice, or a moving image, that is included in the news content. For example, it may be possible to adopt voice data, video data, or the like in a video or stream. Moreover, the information may include a comment that is posted for the news content.

Furthermore, in one embodiment as described above, the different domain may include, in reality, an EC site, a video site, a Q&A site, a specialized website, a life counseling website, or the like.

Moreover, in one embodiment as described above, the server apparatus 100 may generate the appeal text Ap as described below. The server apparatus 100 may generate, for example, the appeal text Ap such as “Hot topic in comment sections of news! Unique perspective on football, baseball, and stock market that are now trending will be provided. Contents that stimulate your interest are carefully selected through latest trends and expert analysis.”

Furthermore, in one embodiment as described above, the server apparatus 100 may generate the overview content Oc as described below.

The server apparatus 100 may generate, for example, the overview content Oc that includes the title T such as “Future prediction for stock market: Where will next bubble come from?”, and the overview text O such as “Prediction for market trends based on current economic situation. Investor's commentary on key points based on simulations using unique economic models. Provided with deep insight that looks into future and that is unevaluable elsewhere.”

Furthermore, the server apparatus 100 may generate, for example, the overview content Oc that includes the title T such as “Must-see for football fans! Ranking of best goals in history”, and the overview text O such as “Best goals that will go down in football history will be introduced in ranking format. Stories behind goals are delved into greater detail with players' interviews and unreleased videos. Provided with ranking based on fan votes, that is, unique ranking from fans' perspective”.

Moreover, the server apparatus 100 may generate, for example, the overview content Oc that includes the title T such as “Future of major league baseball: new era drawn by young players”, and the overview text O such as “Special feature on achievements of promising young players in MLB. Prediction of dawn of new era brought by players based on exclusively obtained development processes and scouting reports of players. Provided with detailed reports that delve into background of development of players, which is not found in other media.”Furthermore, the server apparatus 100 may generate, for example, the overview content Oc that includes the title T such as “Stories behind stock market surge: little-known company growth strategies”, and the overview text O such as “Analysis of growth strategies of companies whose stock prices are soaring. Commentary on company secrets that investors must know, based on interviews with company executives. Provided with in-depth analysis with unique executive interviews.”

However, the above-described cases are mere examples. In reality, embodiments are not limited to the examples as described above.

### 7. Effects

As described above, an information processing apparatus according to the present application (the terminal apparatus 10 and the server apparatus 100) includes the acquisition unit 131 that acquires the user information and the history information on the user U, the estimation unit 132 that estimates a subject of interest of the user U based on the acquired user information and the acquired history information, the collection unit 133 that collects information on a domain corresponding to the estimated subject of interest from among pieces of information that are distributed via a predetermined domain, the determination unit 134 that determines whether or not there is a difference between the collected information on the domain corresponding to the subject of interest and information that corresponds to the subject of interest and that is published via a different domain, the generation unit 135 that, when it is determined that there is the difference, generates the introduction content Ic in which the difference is highlighted based on the collected information on the domain corresponding to the subject of interest, and the providing unit 137 that provides the introduction content.

The determination unit 134 searches for an expression that is included in the collected information on the domain corresponding to the subject of interest through a search engine, and determines whether or not a search result is obtained.

The determination unit 134 determines that there is a difference between the collected information on the domain corresponding to the subject of interest and the information that corresponds to the subject of interest and that is published via the different domain when a search result is not obtained through the search engine, determines whether or not the number of obtained search results is smaller than a threshold when the search result is obtained, and determines that there is a difference between the collected information on the domain corresponding to the subject of interest and the information that corresponds to the subject of interest and that is published via the different domain when the number of the obtained search results is smaller than the threshold.

The determination unit 134 determines whether or not there is a difference by comparing details of the collected information on the predetermined domain and details of the information that is published via the different domain.

The generation unit 135 generates the introduction content Ic for each of the users U.

The generation unit 135 extracts, from among pieces of information that are distributed via the predetermined domain, a content that includes different information from the information that is published via the different domain, makes a list of the extracted content, and generates the overview content Oc that indicates an overview of the listed content.

The generation unit 135 generates the appeal text Ap that is a sentence for appealing the overview content Oc.

The collection unit 133 collects, from the user U, a reaction of the user U with respect to the introduction content Ic.

The information processing apparatus further includes the optimization unit 136 that optimizes the introduction content based on the collected reaction of the user.

The optimization unit 136 optimizes a notification timing at which a notification of the introduction content Ic is given.

Through any of the processes or a combination of the processes as described above, the information processing apparatus according to the present application is able to provide a difference between pieces of information.

### 8. Hardware Configuration

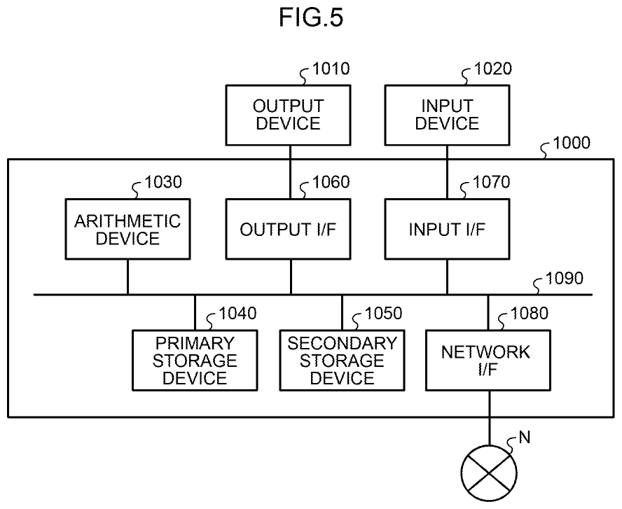

The terminal apparatus 10 and the server apparatus 100 according to one embodiment as described above are implemented by, for example, a computer 1000 that is configured as illustrated in FIG. 5. The server apparatus 100 will be described below as one example. FIG. 5 is a diagram illustrating an example of a hardware configuration. The computer 1000 is connected to an output device 1010 and an input device 1020, and includes an arithmetic device 1030, a primary storage device 1040, a secondary storage device 1050, an output Interface (I/F) 1060, an input I/F 1070, and a network I/F 1080 that are connected to one another via a bus 1090.

The arithmetic device 1030 operates based on a program that is stored in the primary storage device 1040 or the secondary storage device 1050, a program that is read from the input device 1020, or the like, and executes various kinds of processes. The arithmetic device 1030 is implemented by, for example, a Central Processing Unit (CPU), a Micro Processing Unit (MPU), a Graphics Processing Unit (GPU), an Application Specific Integrated Circuit (ASIC), a Field Programmable Gate Array (FPGA), or the like.

The primary storage device 1040 is a memory device, such as a Random Access Memory (RAM), that primarily stores therein data that is used by the arithmetic device 1030 for various kinds of calculations. Further, the secondary storage device 1050 is a storage device in which data that is used by the arithmetic device 1030 for various kinds of calculations and various kinds of databases are recorded, and implemented by a Read Only Memory (ROM), a Hard Disk Drive (HDD), a Solid State Drive (SSD), a flash memory, or the like. The secondary storage device 1050 may be a built-in storage or an external storage. Furthermore, the secondary storage device 1050 may be a removable storage medium, such as a Universal Serial Bus (USB) memory or a Secure Digital (SD) memory card. Moreover, the secondary storage device 1050 may be a cloud storage (online storage), a Network Attached Storage (NAS), a file server, or the like.

The output I/F 1060 is an interface for transmitting output target information to the output device 1010, such as a display, a projector, or a printer, that outputs various kinds of information, and is implemented by, for example, a connector of a certain standard, such as a Universal Serial Bus (USB), a Digital Visual Interface (DVI), or High Definition Multimedia Interface (HDMI) (registered trademark). Further, the input I/F 1070 is an interface for receiving information from various kinds of the input devices 1020, such as a mouse, a keyboard, a keypad, a button, and a scanner, and is implemented by, for example, a USB or the like.

Furthermore, the output I/F 1060 and the input I/F 1070 may be wirelessly connected to the output device 1010 and the input device 1020, respectively. In other words, the output device 1010 and the input device 1020 may be wireless devices.

Moreover, the output device 1010 and the input device 1020 may be integrated with each other as a touch panel.

In this case, the output I/F 1060 and the input I/F 1070 may be integrated with each other as an input-output I/F.

Meanwhile, the input device 1020 may be a device that reads information from, for example, an optical recording medium, such as a Compact Disc (CD), a Digital Versatile Disc (DVD), or a Phase change rewritable Disk (PD), a magneto-optical recording medium, such as a Magneto-Optical disk (MO), a tape medium, a magnetic recording medium, a semiconductor memory, or the like.

The network I/F 1080 receives data from a different apparatus via the network N, sends the data to the arithmetic device 1030, and transmits data generated by the arithmetic device 1030 to a different apparatus via the network N.

The arithmetic device 1030 controls the output device 1010 and the input device 1020 via the output I/F 1060 and the input I/F 1070. For example, the arithmetic device 1030 loads a program from the input device 1020 or the secondary storage device 1050 onto the primary storage device 1040, and executes the loaded program.

For example, when the computer 1000 functions as the server apparatus 100, the arithmetic device 1030 of the computer 1000 executes a program that is loaded on the primary storage device 1040, and implements the functions of the control unit 130. Further, the arithmetic device 1030 of the computer 1000 may load a program that is acquired from a different apparatus via the network I/F 1080 onto the primary storage device 1040, and execute the loaded program. Furthermore, the arithmetic device 1030 of the computer 1000 may cooperate with a different apparatus via the network I/F 1080, and call or use a function of the program, data, or the like from a different program of a different apparatus.

### 9. Others

Thus, embodiments of the present application have been described above, but the present inventio nis not limited by details of the embodiments as described above. In addition, the components described above include one that can be easily thought of by a person skilled in the art, one that is practically identical, and one that is within an equivalent range. Furthermore, the components described above may be combined appropriately. Moreover, within the scope not departing from the gist of the embodiments as described above, various omission, replacement, and modifications of the components may be made.

Furthermore, of the processes described in the embodiments as described above, all or part of a process described as being performed automatically may also be performed manually. Alternatively, all or part of a process described as being performed manually may also be performed automatically by known methods. In addition, the processing procedures, specific names, and information including various kinds of data and parameters illustrated in the above-described document and drawings may be arbitrarily changed unless otherwise specified. For example, various kinds of information illustrated in each of the drawings are not limited to the information illustrated in the drawings.

Furthermore, the components illustrated in the drawings are functionally conceptual and do not necessarily have to be physically configured in the manner illustrated in the drawings. In other words, specific forms of distribution and integration of the apparatuses are not limited to those illustrated in the drawings, and all or part of the apparatuses may be functionally or physically distributed or integrated in arbitrary units depending on various loads or use conditions.

For example, the server apparatus 100 as described above may be implemented by a plurality of server computers, or some of the functions may be implemented by calling an external platform or the like by Application Programming Interface (API), network computing, or the like, that is, the configuration may be changed in a flexible manner.

Moreover, the embodiments and the modifications as described above may be combined appropriately as long as processes do not conflict with each other.

Furthermore, a “unit (section, module, or unit)” described above may be replaced with a “means” or a “circuitry”. For example, the acquisition unit may be replaced with an acquisition means or an acquisition circuitry.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information processing apparatus comprising:
an acquisition unit that acquires user information and history information on a user;
an estimation unit that estimates a subject of interest of the user based on the acquired user information and the acquired history information;
a collection unit that collects information on a domain corresponding to the estimated subject of interest from among pieces of information that are distributed via a predetermined domain;
a determination unit that determines whether or not there is a difference between the collected information on the domain corresponding to the subject of interest and information that corresponds to the subject of interest and that is published via a different domain;
a generation unit that, when it is determined that there is the difference, generates an introduction content in which the difference is highlighted based on the collected information on the domain corresponding to the subject of interest; and
a providing unit that provides the introduction content.

2. The information processing apparatus according to claim 1, wherein the determination unit searches for an expression that is included in the collected information on the domain corresponding to the subject of interest through a search engine, and determines whether or not a search result is obtained.

3. The information processing apparatus according to claim 2, wherein the determination unit determines that there is a difference between the collected information on the domain corresponding to the subject of interest and the information that corresponds to the subject of interest and that is published via the different domain when a search result is not obtained through the search engine, determines whether or not the number of obtained search results is smaller than a threshold when the search result is obtained, and determines that there is a difference between the collected information on the domain corresponding to the subject of interest and the information that corresponds to the subject of interest and that is published via the different domain when the number of the obtained search results is smaller than the threshold.

4. The information processing apparatus according to claim 1, wherein the generation unit generates the introduction content for each of the users.

5. The information processing apparatus according to claim 4, wherein the generation unit extracts, from the collected information on the domain corresponding to the subject of interest, a content that includes different information from the information that corresponds to the subject of interest and that is published via the different domain, makes a list of the extracted content, and generates an overview content that indicates an overview of the listed content.

6. The information processing apparatus according to claim 5, wherein the generation unit generates an appeal text that is a sentence for appealing the overview content.

7. The information processing apparatus according to claim 1, wherein the collection unit collects, from the user, a reaction of the user with respect to the introduction content.

8. The information processing apparatus according to claim 7, further comprising:
an optimization unit that optimizes the introduction content based on the collected reaction of the user.

9. The information processing apparatus according to claim 8, wherein the optimization unit optimizes a notification timing at which a notification of the introduction content is given.

10. An information processing method that is implemented by an information processing apparatus, the information processing method comprising:
acquiring user information and history information on a user;
estimating a subject of interest of the user based on the acquired user information and the acquired history information;
collecting information on a domain corresponding to the estimated subject of interest from among pieces of information that are distributed via a predetermined domain;
determining whether or not there is a difference between the collected information on the domain corresponding to the subject of interest and information that corresponds to the subject of interest and that is published via a different domain;
generating, when it is determined that there is the difference, an introduction content in which the difference is highlighted based on the collected information on the domain corresponding to the subject of interest; and
providing the introduction content.

11. A non-transitory computer readable storage medium having an information processing program stored thereon, wherein the program instructs a computer to execute:
acquiring user information and history information on a user;
estimating a subject of interest of the user based on the acquired user information and the acquired history information;
collecting information on a domain corresponding to the estimated subject of interest from among pieces of information that are distributed via a predetermined domain;
determining whether or not there is a difference between the collected information on the domain corresponding to the subject of interest and information that corresponds to the subject of interest and that is published via a different domain;
generating, when it is determined that there is the difference, an introduction content in which the difference is highlighted based on the collected information on the domain corresponding to the subject of interest; and
providing the introduction content.
